(19) United States
(12) Patent Application Publication
(10) Pub. No.: US 2007/0227672 A1
(43) Pub. Date: Oct. 4, 2007

(54) APPARATUS FOR PREPARING ROLL OF PAPER

(75) Inventor: Yoshikazu Kameda, Noda-shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 11/692,844

(22) Filed: Mar. 28, 2007

(30) Foreign Application Priority Data
Mar. 31, 2006 (JP) 2006-096426

(51) Int. Cl. B65H 19/00; B32B 37/00; B05C 5/02; B32B 38/04

(52) U.S. Cl. 156/502; 156/529; 156/356; 156/524; 156/353

(57) ABSTRACT

After only part of packaging on both lateral ends of the roll of paper is removed, the roll of paper, supported on rolled paper support arms of a rolled paper support apparatus, is set at a predetermined position. A cutter is caused to touch the packaging, and is moved along the width direction of the roll of paper while water is sprayed from the spray nozzle. The packaging and the roll of paper are thus cut in the width direction, and the cut ends of the cut packaging and the roll of paper are prevented from being curled. The upper cut end portions adhere to the outer circumferential surface of the roll of paper, and can be inserted between the table and the clamp bar without failure.

### BACKGROUND OF THE INVENTION

1. Field of the Invention

The present invention relates to a rolled paper preparation apparatus which prepares the beginning of a roll of paper including a web wound.

2. Description of the Related Art

A rotary printing press or the like which prints on webs is provided with a rolled paper preparation apparatus which prepares the beginning of a new roll of paper to be spliced so that the new roll of paper can be pasted. This is for changing rolls of paper which include webs wound so that the webs can be continuously fed when diameter of the roll of paper in operation becomes small by pasting the beginning of the new roll of paper onto the roll of paper in operation and then by cutting the roll of paper in operation in the middle (Japanese Patent Application Laid-open No. Hei10-157892).

In an operation of preparing a roll of paper using a rolled paper preparation apparatus described above, an operator loads the roll of paper onto a support apparatus after removing all packaging in which the roll of paper is wrapped up from the roll of paper. Accordingly, such an operation before the preparation operation takes a lot of effort, and the operation efficiency is very low.

### SUMMARY OF THE INVENTION

The present invention provides a rolled paper preparation apparatus capable of facilitating the operation before preparation of a roll of paper.

To solve the aforementioned problems, a rolled paper preparation apparatus according to the present invention provides a rolled paper preparation apparatus for preparing a beginning of a roll of paper including a web wound, which comprises: liquid attachment means attaching liquid in a width direction of the roll of paper to packaging wrapped around the roll of paper is wrapped; and cutting means which cuts an area of the packaging to which the liquid is attached and the roll of paper in a width direction of the roll of paper.

Moreover, the rolled paper preparation apparatus according to the present invention provides the above-described rolled paper preparation apparatus, which further includes: peel-off means peeling off cut ends of the packaging and roll of paper by rotation of the roll of paper from an outer circumferential surface of the roll of paper which is not cut by the cutting means.

Still moreover, the rolled paper preparation apparatus according to the present invention provides the above-described rolled paper preparation apparatus, which further includes: web holding means holding the cut ends of the packaging and roll of paper which are peeled off from the outer circumferential surface of the roll of paper not cut by the cutting means.

Still moreover, the rolled paper preparation apparatus according to the present invention provides the above-described rolled paper preparation apparatus, wherein the liquid attachment means includes: a spray nozzle spraying water; and a water supply apparatus supplying water to the spray nozzle.

Still moreover, the rolled paper preparation apparatus according to the present invention provides the above-described rolled paper preparation apparatus, wherein the liquid attachment means is movable in the width direction of the roll of paper.

Still moreover, the rolled paper preparation apparatus according to the present invention provides the above-described rolled paper preparation apparatus, which further includes: liquid-attachment-stop-timing detection means which detects a time when to stop attachment of the liquid to the packaging by the liquid attachment means; and a controller which controls the liquid attachment means, in response to a signal from the liquid-attachment-stop-timing detection means, such that the attachment of the liquid to the packaging is stopped.

Still moreover, the rolled paper preparation apparatus according to the present invention provides the above-described rolled paper preparation apparatus, wherein the liquid-attachment-stop-timing detection means is outside-edge detection means detecting an outside edge of the roll of paper in the width direction.

Still moreover, the rolled paper preparation apparatus according to the present invention provides the above-described rolled paper preparation apparatus, which further includes: moving means moving the cutting means in the width direction of the roll of paper.

Still moreover, the rolled paper preparation apparatus according to the present invention provides the above-described rolled paper preparation apparatus, which further includes: a guide member entering between layers of the web of the roll of paper.

Still moreover, the rolled paper preparation apparatus according to the present invention provides the above-described rolled paper preparation apparatus, which further includes: a press member holding the packaging.

Still moreover, the rolled paper preparation apparatus according to the present invention provides the above-described rolled paper preparation apparatus, wherein the press member is supported on the cutting means.

Still moreover, the rolled paper preparation apparatus according to the present invention provides the above-described rolled paper preparation apparatus, wherein the press member is provided for a downstream side of the cutting means in a direction that the cutting means is moved by the moving means.

Still moreover, the rolled paper preparation apparatus according to the present invention provides the above-described rolled paper preparation apparatus, wherein the liquid attachment means is supported on the cutting means.

Still moreover, the rolled paper preparation apparatus according to the present invention provides the above-described rolled paper preparation apparatus, wherein the press member is provided for a downstream side of the cutting means in a direction that the cutting means is moved by the moving means.

Still moreover, the rolled paper preparation apparatus according to the present invention provides the above-described rolled paper preparation apparatus, which further includes: a controller which controls the moving means such that the cutting means is moved in the width direction of the roll of paper, and which controls the liquid attachment means such that the liquid is attached to the packaging.

Still moreover, the rolled paper preparation apparatus according to the present invention provides the above-described rolled paper preparation apparatus, which further includes: approach-and-separation means which moves the cutting means between an operation position where the cutting means cuts the roll of paper and the packaging, and a retracted position away from the operation position.

Still moreover, the rolled paper preparation apparatus according to the present invention provides the above-described rolled paper preparation apparatus, wherein the liquid attachment means is supported on the cutting means such that the liquid attachment means is faced to the packaging when the cutting means is located at the operation position.

Still moreover, the rolled paper preparation apparatus according to the present invention provides the above-described rolled paper preparation apparatus, which further includes: cutting position detection means detecting a position of the cutting means relative to the packaging; and a controller which controls the approach-and-separation means in response to a signal from the cutting position detection means, such that the approach-and-separation means locate the cutting means at the operation position.

Still moreover, the rolled paper preparation apparatus according to the present invention provides the above-described rolled paper preparation apparatus, wherein the cutting position detection means is distance measuring means which measures a distance from the packaging.

Still moreover, the rolled paper preparation apparatus according to the present invention provides the above-described rolled paper preparation apparatus, which further includes: moving means which moves the cutting means in the width direction of the roll of paper, in the rolled paper preparation apparatus, the controller controls the moving means such that the cutting means can move in the width direction of the roll of paper after controlling the approach-and-separation means, in response to a signal from the distance measuring means, such that the cutting means touches the packaging.

### BRIEF DESCRIPTION OF THE DRAWINGS

The present invention will become more fully understood from the detailed description given hereinbelow and the accompanying drawings which are given by way of illustration only, and thus are not limitative of the present invention and where in;

FIG. 1 shows a side view showing schematically a structure of an embodiment of a rolled paper preparation apparatus according to the present invention;

FIG. 2 shows a plan view of a part indicated by an arrow II in FIG. 1;

FIG. 3 shows a plan view of a part indicated by an arrow III in FIG. 1;

FIG. 4 shows a block diagram of a control system of a main portion of the rolled paper preparation apparatus of FIG. 1; and

FIG. 5 shows an explanatory view of an operation of the rolled paper preparation apparatus of FIG. 1.

### DETAILED DESCRIPTION OF THE INVENTION

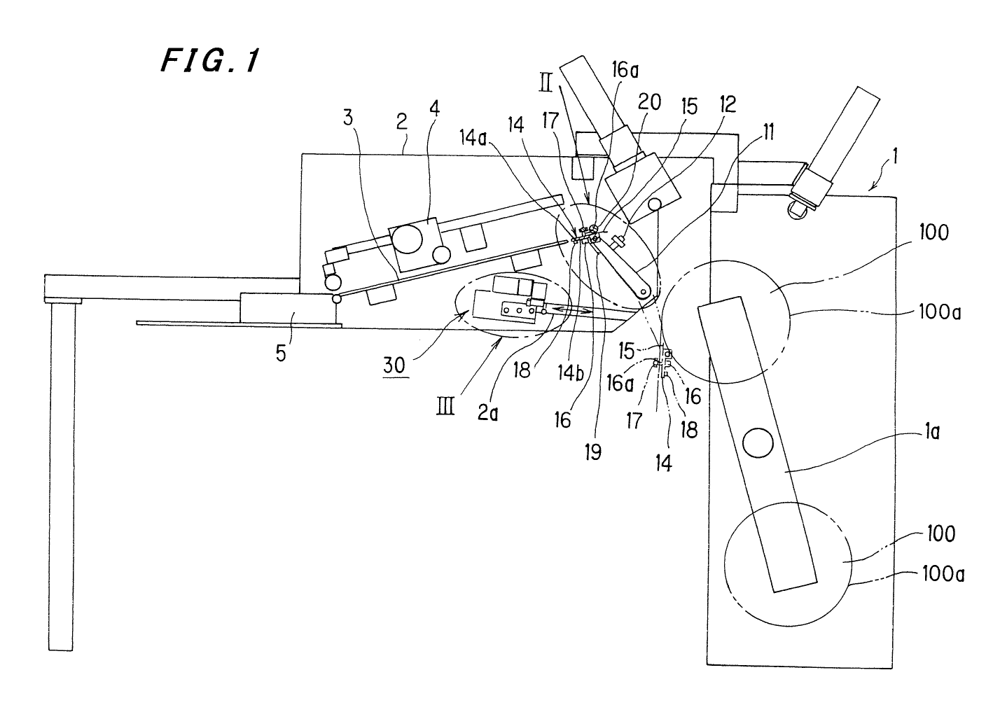

Embodiments of a rolled paper preparation apparatus according to the present invention will be described by referring to FIGS. 1 to 5.

In FIG. 1, reference numeral 1 denotes a rolled paper support apparatus; 1a, rolled paper support arms; 2, fixed frames; 3, a work table; 4, a beginning processing apparatus; 5, a paper discharge box; 100, rolls of paper including webs wound; 100a, packaging wrapped around the outer circumferential surface of each roll of paper 100. The pair of rolled paper support arms 1a, which are provided for the rolled paper support apparatus 1, support the rolls of paper 100 on both ends so as to drive and rotate the rolls of paper 100. The pair of rolled paper support arms 1a can rotate about a middle part so that one of the rolls of paper 100 is set at a predetermined position.

The fixed frames 2 are disposed on distal end sides of the rolled paper support arms 1a in an upper part of the rolled paper support apparatus 1. The work table 3 is supported by the fixed frames 2 and includes a lot of suction holes (not-shown) formed on the surface so as to suck and hold the web fed from each roll of paper 100. The beginning processing apparatus 4 is supported by the fixed frames 2, and automatically performs an operation of preparing the beginning of the web from the roll of paper 100 which is sucked and held by the work table 3. The paper discharge box 5 is configured to receive paper which becomes wasted by preparation on the work table 3.

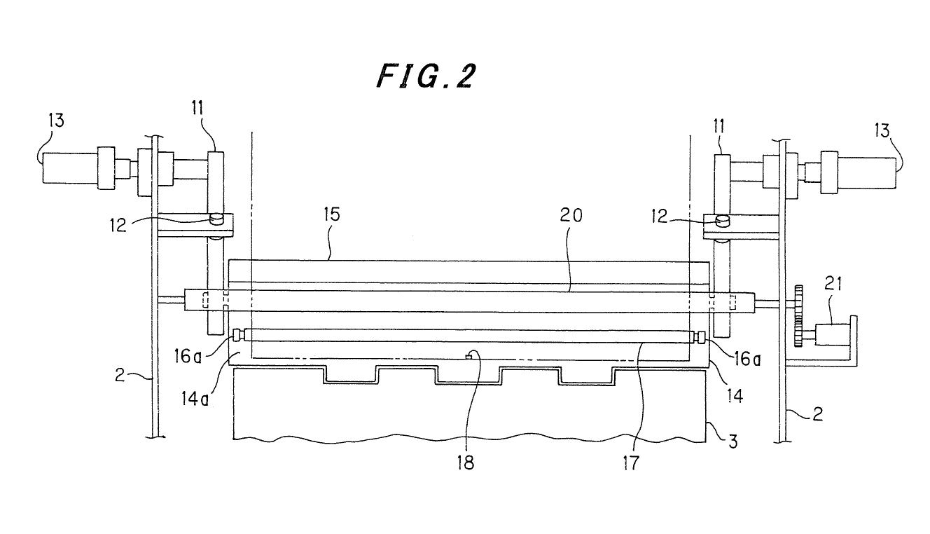

As shown in FIGS. 1 and 2, proximal ends of a pair of arms 11 are rotatably supported on the fixed frames 2. Distal ends of the arms 11 are configured to reciprocate between a first position near the work table 3 and a second position near the packaging 100a on the outer circumferential surface of the upper roll of paper 100 which is set at the predetermined position by rotation of the rolled paper support arms 1a of the rolled paper support apparatus 1, the second position being below the axial center of the roll of paper 100. To the fixed frames 2, stoppers 12 are attached. The stoppers 12 position and stop the distal ends of the arms 11 at predetermined positions of the second position near the work table 3. To the proximal ends of the arms 11, drive motors 13, which synchronously rotate the arms 11, are individually coupled.

Between the distal ends of the arms 11, a table 14, which connects to the work table 3, is disposed. Proximal part of the table 14 is rotatably supported on the distal ends of the arms 11. On the proximal end of the table 14, a scraper 15 is protruded. When the distal ends of the arms 11 are located in the vicinity of the packaging 100a on the outer circumferential surface of the upper roll of paper 100 set at the predetermined position, the scraper 15 touches the packaging 100a on the outer circumferential surface of the roll of paper 100 below the axial center of the upper roll of paper 100. The scraper 15 is composed of an elastic material such as rubber and resin, and an edge of the scraper 15 is bent.

In the vicinity of side edges, on the arms 11 sides, of a back surface 14b of the table 14, air cylinders 16 are individually provided. The air cylinders 16 individually include retractable rods 16a protruded on a receiving surface 14a side of the table 14. Between tops of the rods 16a of the air cylinders 16, a clamp bar 17 is disposed. Ends of the clamp bar 17 are supported on the tops of the rods 16a. On the other side of the table 14, that is, on a part of the table 14 near an edge which connects to the work table 3, an end detection sensor 18, which detects an end of the web of the roll of paper 100, is provided.

In the distal portions of the arms 11, stoppers 19 are attached. The stoppers 19 position and support the table 14 so that the receiving surface 14a of the table 14 and the upper surface of the work table 3 can form substantially a single plane when the arms 11 are located at positions where the arms 11 touch the stoppers 12, that is, at connecting positions where the table 14 connects to the work table 3. On the fixed frames 2, a roller 20 is rotatably supported. When the arms 11 are located at the positions where the arms 11 touch the stoppers 12, that is, at the connecting positions where the table 14 connects to the work table 3, the roller 20 touches the receiving surface 14a of the table 14. The roller 20 is configured to be rotationally driven by a drive motor 21.

In this embodiment, the scraper 15 and the like constitute peel-off means; the table 14, the air cylinders 16, the clamp bar 17, and the like constitute web holding means; and the arms 11, the stoppers 12 and 19, the drive motors 13, and the like constitute web moving means.

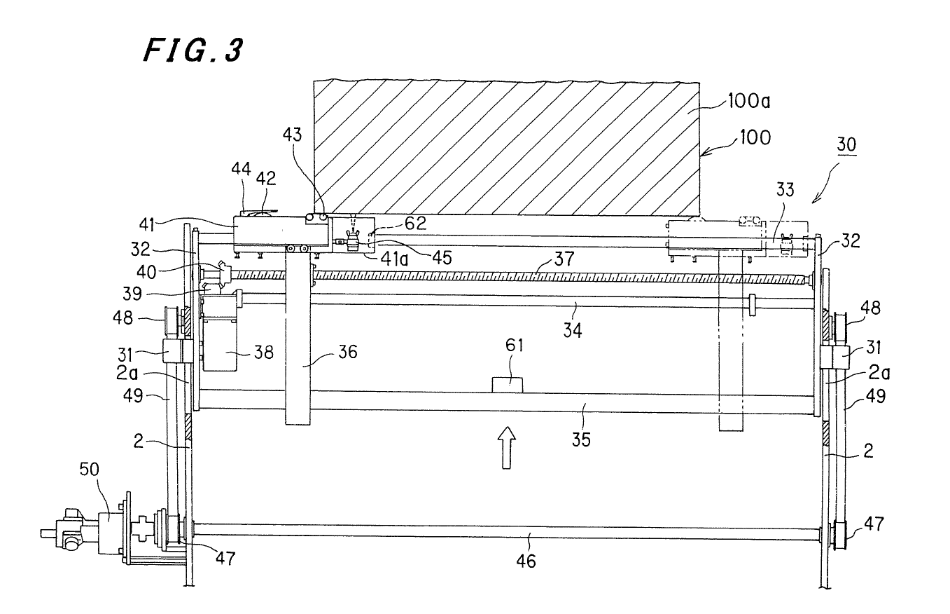

On the other hand, as shown in FIGS. 1 and 3, a cutting apparatus 30 is provided for the fixed frames 2 below the work table 3. The cutting apparatus 30 cuts the roll of paper 100 and the packaging 100a, set at the predetermined position, in the width direction. The cutting apparatus is allowed to move so as to be brought close to and away from the packaging 100a. The cutting apparatus 30 has a structure shown in the following.

As shown in FIGS. 1 and 3, slide blocks 31 are individually attached to slide grooves 2a so as to slide on the slide grooves 2a. The slide grooves 2a are individually formed on the fixed frames 2 below the work table 3. On inner sides of the slide blocks 31 in a direction that the fixed frames 2 oppose each other, slide plates 32 are individually attached. Between the slide plates 32, support beams 33 to 35 are attached so that longitudinal directions thereof extend in the width direction of the roll of paper 100 set at the predetermined position.

To the support beams 34 and 35, a moving block 36 is attached so as to move in the longitudinal direction of the support beams 34 and 35. This moving block 36 is screwed onto a threaded shaft 37, which is rotatably supported between the slide plates 32. To a first one of the slide plates 32, a forward/reverse drive motor 38 is attached. A bevel gear 39, which is attached to a drive shaft of the drive motor 38, meshes with a bevel gear 40, which is provided coaxially with the threaded shaft 37.

When the drive motor 38 is driven, the threaded shaft 37 is rotated via the bevel gears 39 and 40, and the moving block 36, which is screwed onto the threaded shaft 37, can reciprocate along the support beams 34 and 35.

To the support beam 33, which is situated near the packaging 100a on the outer circumferential surface of the roll of paper 100 which is set at the predetermined position (on a front side), a cutter case 41 is attached so as to slide along the support beam 33. The proximal end of the cutter case 41 is coupled to the moving block 36. The cutter case 41 is configured to be capable of reciprocating along the support beam 33 with the aforementioned movement of the moving block 36 by driving the drive motor 38.

To a distal portion of the cutter case 41 on a second on of the slide plates 32 side (on the downstream side in the moving direction), a press member 43 is attached. The press member 43 holds the packaging 100a on the outer circumferential surface of the roll of paper 100 set at the predetermined position. On a distal portion of the cutter case 41 on the first slide plate 32 side (on the upstream side in the moving direction), a guide member 44 is attached. The guide member 44 enters between layers of the wound web of the roll of paper 100 set at the predetermined position. Between the distal end of the cutter case 41 and the guide member 44, a cutter 42 is rotatably provided.

To an end face of the cutter case 41 on a second one of the slide plates 32 side, a spray nozzle 45 is attached. By the spray nozzle 45, liquid, specifically water, is sprayed, and is attached to the packaging 100a on the outer circumferential surface of the roll of paper 100 set at the predetermined position. This spray nozzle 45 is connected to a water supply apparatus (not-shown) supplying water.

Between the fixed frames 2, a transmission shaft 46 is rotatably supported. On ends of the transmission shaft 46, which ends protrude outward in the direction that the fixed frames 2 oppose each other, pulleys 47 are individually attached coaxially with each other. In front portions of the fixed frames 2 outside in the direction that the fixed frames 2 oppose each other, pulleys 48 are individually attached so as to rotate. Between the pulleys 47 and 48, belts 49 are individually looped. The slide blocks 31 are individually fixed to the belts 49. The pulley 47 on a first one of the fixed frames 2 is coaxially coupled to a drive shaft of a forward/reverse air motor 50, which is supported on the first fixed frame 2.

By driving the air motor 50, the pulleys 47 and 48 rotate to move the belts 49, and the slide blocks 31 slide along the slide grooves 2a of the fixed frames 2. Thus, the cutter case 41 is brought close to and away from the packaging 100a on the outer circumferential surface of the upper roll of paper 100. Moreover, the spray nozzle 45 can be faced to the packaging 100a on the outer circumferential surface of the roll of paper 100 when the cutter case 41 is brought close to the packaging 100a on the outer circumferential surface of the roll of paper 100.

To the support beam 35, a distance measuring sensor 61 as cutting position detection means, or as distance measuring means, is attached. The distance measuring sensor 61 measures a position of the cutter 42 relative to the packaging 100a on the outer circumferential surface of the roll of paper 100 set at the predetermined position, or measures a distance from the packaging 100a. To the cutter case 41, an outside-edge detection sensor 62 as liquid-attachment-stop-timing detection means, or as outside-edge detection means, is attached with a bracket 41a interposed therebetween. The outside-edge detection sensor 62 detects a time when to stop the spraying of water from the spray nozzle 45 to the packaging 100a, or detects an outside edge of the roll of paper 100 set at the predetermined position in the width direction.

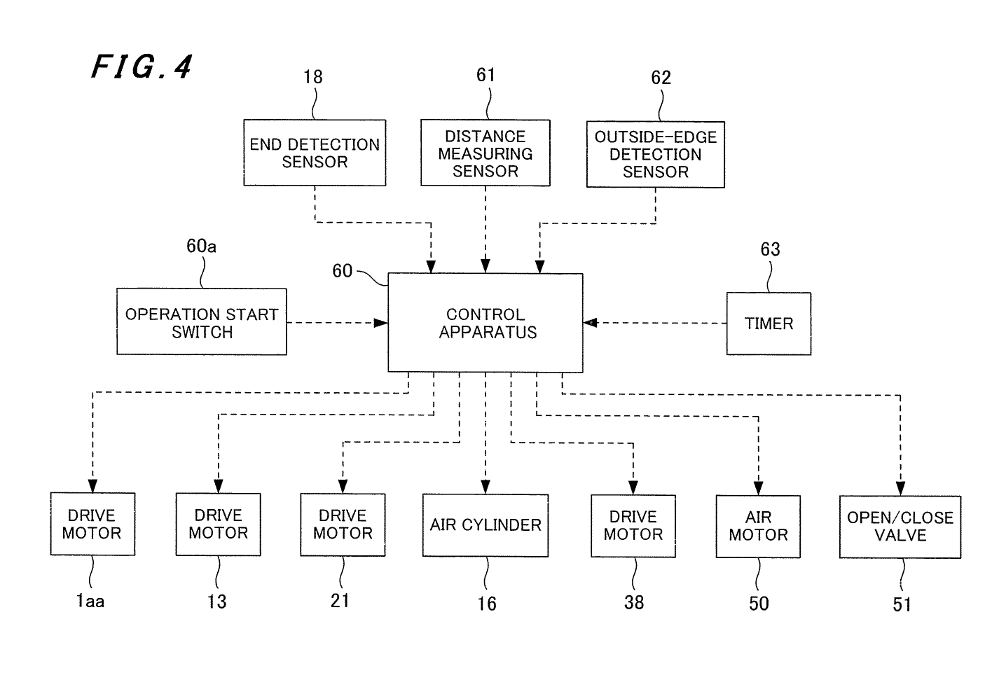

As shown in FIG. 4, the distance measuring sensor 61, outside-edge detection sensor 62, and end detection sensor 18 are electrically connected individually to an input section of a control apparatus 60 as a controller. Moreover, the input section of the control apparatus 60 is also electrically connected to an operation start switch 60a and a timer 63. An output section of the control apparatus 60 is electrically connected individually to the drive motor 38, the air motor 50, the open/close valve 51 of the water supply apparatus, the drive motor 13, the air cylinders 16, the drive motor 21, a drive motor 1aa, which drives and rotates the roll of paper 100 and the packaging 100a, supported by the rolled paper support arms 1a. The control apparatus 60 is configured to control operations of the motors 1aa, 13, 21, 38, and 50, the air cylinders 16, the open/close valve 51 of the water supply apparatus in response to signals from the sensors 18, 61, and 62, the operation start switch 60a, the timer 63, and the like (details thereof are described later).

In this embodiment, the cutter case 41, the cutter 42, and the like constitute cutting means; the slide blocks 31, the slide plates 32, the support beam 33, the transmission shaft 46, the pulleys 47 and 48, the belts 49, the air motor 50, and the like constitute approach-and-separation means; the support beams 34 and 35, the moving block 36, the threaded shaft 37, the drive motor 38, the bevel gears 39 and 40, and the like constitute moving means; and the spray nozzle 45, the water supply apparatus including the open/close valve 51, and the like constitute liquid attachment means.

Next, a description is given of an operation of the rolled paper preparation apparatus structured as described above.

Firstly, only portions of the packaging on both lateral ends of the roll of paper 100 is removed, and then the rolled paper support arms 1a of the rolled paper support apparatus 1 supporting the roll of paper 100 are rotated to set the roll of paper 100 at the predetermined position. When the operation start switch 60a is then turned on, in response to the signal from the distance measuring sensor 61, the control apparatus 60 drives the air motor 50. The air motor 50 moves the cutter case 41 until the press member 43 provided on the distal end of the cutter case 41 touches the packaging 100a on the outer circumferential surface of the roll of paper 100 and the spray nozzle 45 is faced to the packaging 100 on the outer circumferential surface of the roll of paper 100.

When the cutter case 41 is located at the operation position, the control apparatus 60 activates the drive motor 38. The drive motor 38 rotates the threaded shaft 37 until the cutter case 41 slides from the first slide plate 32 side toward the second slide plate 32 side. Moreover, the control apparatus 60 opens the open/close valve 51 of the water supply apparatus so that water can be sprayed from the spray nozzle 45. Thus, water is sprayed to the packaging 100a along the width direction of the roll of paper 100.

By such movement of the cutter case 41, the guide member 44 enters between the layers of the web of the roll of paper 100 (the position several layers below the surface including the packaging 100a) while the cutter 42 cuts the roll of paper 100 and the packaging 100a between the cutter case 41 and the guide member 44.

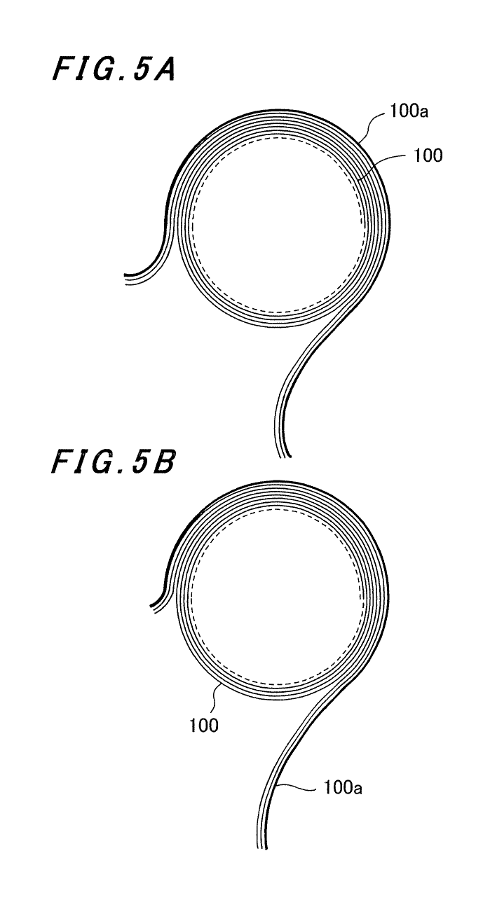

At this time, some kinds of packaging 100a may cause the drying of cut ends of the packaging 100a and the roll of paper 100, cut by the cutter 42, and the cut ends may be curled as shown in FIG. 5A. The curling, however, is prevented as the cut ends are wetted by water sprayed as described above. Accordingly, the upper cut ends adhere to the outer circumferential surface of the roll of paper 100 while the lower cut ends are weighed down with their own weight, as shown in FIG. 5B. Moreover, paper dust and the like generated by the cutting is sucked to adhere to and is held on the packaging 100a.

Upon the outside-edge detection sensor 62 detecting the outside edge of the roll of paper 100 on the second slide plate 32 side, the control apparatus 60 closes the open/close valve 51 of the water supply apparatus so as to stop the spraying of water from the spray nozzle 45. In addition, the control apparatus 60, in response to information from the timer 63, activates the drive motor 38 to return the cutter case 41 to the first slide plate 32 side a predetermined period of time after the detection of the outside edge of the roll of paper 100, or after the roll of paper 100 and packaging 100a is entirely cut in the width direction.

Subsequently, the control apparatus 60 activates the air motor 50 to slide the slide plates 32 with the pulleys 47 and 48, the belts 49, and the slide blocks 31. By the movement of the slide plates 32, the cutter case 41 is brought away from the packaging 100a and the outer circumferential surface of the roll of paper 100, to a retracted position away from the operation position.

Next, the control apparatus 60 activates the drive motor 13 to rotate the arms 11 so that the distal ends of the arms 11 can be located in the vicinity of the roll of paper 100 (from a position indicated by a solid line to a position indicated by a chain double-dashed line in FIG. 1). The table 14 then rotates by its own weight so that the receiving surface 14a extends along a vertical plane with such rotation, and the edge of the scraper 15 touches the outer circumferential surface of the roll of paper 100 below the axial center of the roll of paper 100.

Subsequently, when the control apparatus 60 activates the drive motor 1aa of the rolled paper support apparatus 1 to rotate the roll of paper 100, the upper cut ends of the cut packaging 100a and roll of paper 100 are peeled off from the outer circumferential surface. The upper cut ends thus peeled off are guided onto the receiving surface 14a of the table 14 by the scraper 15, and enter between the receiving surface 14a of the table 14 and the clamp bar 17.

Upon the end detection sensor 18 detecting the aforementioned end portions of the packaging 100a and roll of paper 100, the control apparatus 60 stops the operation of the drive motor 1aa of the rolled paper support apparatus 1 in response to the result of the detection by the end detection sensor 18. Thus, the rotation of the roll of paper 100 is stopped, and then the rods 16a of the air cylinders 16 is retracted.

The fed web of the roll of paper 100 and the packaging 100a are thus held between the clamp bar 17 and the receiving surface 14a of the table 14.

Next, the control apparatus 60 activates the drive motor 13 to rotate the arms 11 until the arms 11 touch the stoppers 12 (from the position indicated by the chain double-dashed line to the position indicated by the solid line in FIG. 1). The table 14 rotates with the rotation of the arms 11, while the stoppers 19 supports the table 14, until the receiving surface 14a of the table 14 connects to the upper surface of the work table 3 to form substantially a single plane, and until the roller 20 touches the packaging 100a on the receiving surface 14a of the table 14. During the rotation of the arms 11, the control apparatus 60 activates the drive motor 1aa of the rolled paper support apparatus 1. The drive motor 1aa thus rotates the roll of paper 100 and feeds the web to apply a certain tension to the web fed from the roll of paper 100.

Subsequently, the control apparatus 60 extends the rods 16a of the air cylinders 16. Thus, the web, fed from the roll of paper 100, and the packaging 100a are released from the state in which the web and the packaging 100a are held by the clamp bar 17. The control apparatus 60 then activates the drive motor 1aa of the rolled paper support apparatus 1 to rotate the roll of paper 100, and activates the drive motor 21 to rotate the roller 20.

The cut off pieces of the roll of paper 100 and packaging 100a are thus discharged from the receiving surface 14a of the table 14 via the upper surface of the work table 3 into the paper discharge box 5. Moreover, the beginning part of the fed roll of paper 100 is placed on the receiving surface 14a of the table 14.

When beginning part of the roll of paper 100 of a predetermined length is fed onto the receiving surface 14a of the table 14, the beginning part of the roll of paper 100 is held on the work table 3 by suction through the suction holes of the work table 3, and is subjected to the preparation operation by the beginning preparation apparatus 4. The preparation operation includes an operation of cutting the roll of paper 100 on the beginning side, an operation of applying two-sided adhesive tape, an operation of attaching a tab, and the like. The beginning of the roll of paper 100 is then wound back by a rotation of the roll of paper 100 in the rotational direction opposite the one mentioned above, while the rotation is caused by an activation of the drive motor 1aa. Then, the beginning of the roll of paper 100 is temporarily fixed to the outer circumferential surface by the tab, and thus the preparation operation is completed.

According to the above-described rolled paper preparation apparatus, the following effects can be obtained.

Firstly, the operation of preparing the roll of paper 100 can be performed only by removing a part of the packaging (both lateral ends). Accordingly, the operation before preparation can be considerably simplified and facilitated, and thus the working efficiency is increased.

Secondly, the cutter case 41 is brought close to the packaging 100a on the outer circumferential surface of the roll of paper 100 while the distance between the packaging 100a on the outer circumferential surface of the roll of paper 100 and the cutter case 41 is checked on the basis of the signal from the distance measuring sensor 51. Accordingly, the roll of paper 100 and packaging 100a can be cut without failure regardless of the diameter of the roll of paper 100.

Thirdly, when the cutter 42 cuts the packaging 100a and the roll of paper 100, the press member 43 holds the packaging 100a on the outer circumferential surface of the roll of paper 100. Accordingly, the packaging 100a and the roll of paper 100 can be cut without failure.

Fourthly, the guide member 44 is inserted between the layers of the web of the roll of paper 100, and then the packaging 100a and the web between the cutter case 41 and the guide member 44 is cut by the cutter 42. Accordingly, the same number of layers of the web can be cut together with the packaging 100a all along the width direction. Thus, any partially cut web does not remain on the receiving surface 14a of the table 14 when the predetermined length of the web of the roll of paper 100 on the beginning side is fed onto the receiving surface 14a of the table 14. Consequently, it is unnecessary to remove the partially cut web before the preparation operation, thus increasing the working efficiency.

Fifthly, water is sprayed to the packaging 100a from the spray nozzle 45 to wet the packaging 100a. Accordingly, the cut ends of the cut packaging 100a and the roll of paper 100 can be prevented from curling. The upper cut end portions thereof can be caused to adhere to the outer circumferential surface of the roll of paper 100 while the lower cut ends can be weighed down with their own weight. Besides, the paper dust and the like generated by cutting can be sucked to be adhered to and can be held on the packaging 100a. The upper cut ends of the cut roll of paper 100 and the packaging 100a can be therefore inserted between the clamp bar 17 and the receiving surface 14a of the table 14 without failure. As a result, web fed from the roll of paper 100 and the packaging 100a can be held between the clamp bar 17 and the receiving surface 14a of the table 14 without failure, and can be conveyed onto the work table 3. Moreover, the paper dust and the like can be collected together with the packaging 100a without being scattered around the area.

Sixthly, water is sprayed to the packaging 100a from the water nozzle 45 before the roll of paper 100 and the packaging 100a is cut with the cutter 42. Accordingly, it is possible to wet only the packaging 100a without wetting the roll of paper 100.

In this embodiment, the spray nozzle 45 is attached to the cutter case 41, and the packaging 100a is wetted by spraying water thereto while the spray nozzle 45 is being moved, together with the cutter 42, in the width direction of the roll of paper 100. As another embodiment, for example, the spray nozzle 45 can be moved in the width direction of the roll of paper 100 by a transfer mechanism different from the transfer mechanism to move the cutter 42 in the width direction of the roll of paper 100. As still another embodiment, it is possible to provide a plurality of spray nozzles at predetermined intervals all along the width direction of the roll of paper 100 to allow the packaging 100a to be wetted all along the width direction of the roll of paper 100 without moving the spray nozzle 45 in the width direction of the roll of paper 100. However, according to this embodiment, only one spray nozzle 45 is needed and so is the transfer mechanism. Thus, the structure can be simplified and the costs can be reduced.

In this embodiment, the packaging 100a and the roll of paper 100 are cut by moving the cutter 42 in the width direction of the roll of paper 100. As another embodiment, for example, the packaging 101a and the roll of paper 100 can be cut by causing a cutter with an edge of the same length as the width of the roll of paper 100 to be brought close to and pressed against the packaging 101a on the outer circumferential surface of the roll of paper 100.

The approach-and-separation means, the moving means, the cutting means, the liquid attachment means and the like described above are not limited to means composed of the aforementioned members. These means and the like can be composed of other members including similar functions.

According to the rolled paper preparation apparatus according to the present invention, the operation of preparing a roll of paper is carried out only by removing a part of packaging (both lateral end portions). It is therefore possible to considerably simplify and facilitate the operation before preparation and increase the working efficiency.

The rolled paper preparation apparatus according to the present invention can considerably simplify and facilitate the operation before preparation, thus increasing the working efficiency. Accordingly, the rolled paper preparation apparatus according to the present invention can be put to extremely good use in printing industries and the like.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A rolled paper preparation apparatus for preparing a beginning of a roll of paper including a web wound, comprising:
liquid attachment means attaching liquid in a width direction of the roll of paper to packaging wrapped around the roll of paper; and
cutting means which cuts an area of the packaging to which area the liquid is attached and the roll of paper in a width direction of the roll of paper.

2. The rolled paper preparation apparatus according to claim 1, further comprising:
peel-off means peeling off cut ends of the packaging and roll of paper, by a rotation of the roll of paper, from an outer circumferential surface of the roll of paper which is not cut by the cutting means.

3. The rolled paper preparation apparatus according to claim 2, further comprising:
web holding means holding the cut ends of the packaging and roll of paper which are peeled off from the outer circumferential surface of the roll of paper not cut by the cutting means.

4. The rolled paper preparation apparatus according to claim 1, wherein the liquid attachment means includes a spray nozzle spraying water and a water supply apparatus supplying water to the spray nozzle.

5. The rolled paper preparation apparatus according to claim 1, wherein the liquid attachment means is movable in the width direction of the roll of paper.

6. The rolled paper preparation apparatus according to claim 5, further comprising:
liquid-attachment-stop-timing detection means which detects a time when to stop attachment of the liquid to the packaging by the liquid attachment means; and
a controller which controls the liquid attachment means, in response to a signal from the liquid-attachment-stop-timing detection means, and which causes the attachment of the liquid to the packaging to be stopped.

7. The rolled paper preparation apparatus according to claim 6, wherein the liquid-attachment-stop-timing detection means is outside-edge detection means detecting an outside edge of the roll of paper in the width direction.

8. The rolled paper preparation apparatus according to claim 1, further comprising:
moving means moving the cutting means in the width direction of the roll of paper.

9. The rolled paper preparation apparatus according to claim 8, further comprising:
a guide member entering between layers of the web of the roll of paper.

10. The rolled paper preparation apparatus according to claim 8, further comprising:
a press member holding the packaging.

11. The rolled paper preparation apparatus according to claim 10, wherein the press member is supported on the cutting means.

12. The rolled paper preparation apparatus according to claim 11, wherein the press member is provided for a downstream side of the cutting means in a direction that the cutting means is moved by the moving means.

13. The rolled paper preparation apparatus according to claim 8, wherein the liquid attachment means is supported on the cutting means.

14. The rolled paper preparation apparatus according to claim 13, wherein the liquid attachment means is provided for a downstream side of the cutting means in a direction that the cutting means is moved by the moving means.

15. The rolled paper preparation apparatus according to claim 8, further comprising:
a controller which controls the moving means such that the cutting means is moved in the width direction of the roll of paper, and which controls the liquid attachment means such that the liquid is attached to the packaging.

16. The rolled paper preparation apparatus according to claim 1, further comprising:
approach-and-separation means which moves the cutting means between an operation position where the cutting means cuts the roll of paper and the packaging, and a retracted position away from the operation position.

17. The rolled paper preparation apparatus according to claim 16, wherein the liquid attachment means is supported on the cutting means such that the liquid attachment means is faced to the packaging when the cutting means is located at the operation position.

18. The rolled paper preparation apparatus according to claim 16, further comprising:
cutting position detection means which detects a position of the cutting means relative to the packaging; and
a controller which controls the approach-and-separation means in response to a signal from the cutting position detection means such that the cutting means is located at the operation position.

19. The rolled paper preparation apparatus according to claim 18, wherein the cutting position detection means is distance measuring means which measures a distance from the packaging.

20. The rolled paper preparation apparatus according to claim 19, further comprising:
moving means which moves the cutting means in the width direction of the roll of paper; wherein
the controller which controls the moving means such that the cutting means is moved in the width direction of the roll of paper after controlling the approach-and-separation means in response to a signal from the distance measuring means such that the cutting means touches to the packaging.
